(19) United States
(12) Patent Application Publication
(10) Pub. No.: US 2012/0101868 A1
(43) Pub. Date: Apr. 26, 2012

(54) METHOD AND SYSTEM FOR REVERSE TRANSFERRING KNOWLEDGE BETWEEN PROJECT TEAMS

(75) Inventors: Srihari Gopalan, Chennai (IN); Visvanathan Lakshmi Narayan, Chennai (IN); Gayathri Vivekanandan, Chennai (IN)

(73) Assignee: INFOSYS TECHNOLOGIES LIMITED, Bangalore (IN)

(21) Appl. No.: 13/072,367

(22) Filed: Mar. 25, 2011

(30) Foreign Application Priority Data
Oct. 22, 2010 (IN) 3131/CHE/2010

(51) Int. Cl. G06Q 10/00

(52) U.S. Cl. 705/7.15; 705/7.13

(57) ABSTRACT

The present invention provides a method and a system for reverse transferring knowledge of a project from a primary vendor to a secondary vendor. The reverse knowledge transfer process involves defining a seamless process for transferring knowledge of all applications of the project, without compromising on the committed timelines for the release of the applications. Further, the knowledge transfer process is regularly monitored and controlled by various stakeholders to ensure the timelines are met and quality of transfer is maintained.

### FIELD OF THE INVENTION

The present invention relates, generally, to the domain of knowledge transfer and, more specifically, to transferring knowledge during transitioning from one vendor to another vendor.

### BACKGROUND OF THE INVENTION

Knowledge is one of the most important assets of an organization. It has been speculated that the ability of an enterprise to capture and share knowledge, and its ability to reuse, reinvent, and innovate using that knowledge will become a key determinant and predictor of the enterprise's value in the near future. For efficient transfer of one function from an organization to another, it is imperative to transfer the existing knowledge efficiently.

Customers seeking to implement knowledge transfer operations for new technology should seek to utilize the most effective operation. Therefore, when a customer uses a particular knowledge transfer operation which is not beneficial, he/she not only stands to lose on the investment made on implementation, but also further expenses due to follow-up requirements if vendors do not fully understand the new technology.

Due to competition and various other reasons, customers are also looking at transitioning the operations from existing vendors to a new vendor. This requires the customers to transfer the knowledge again, which was previously transferred to the first vendor. During the course of time, the first vendor uses and innovates using the previous knowledge received from the customer and takes the project or process to the next level of development. However, as the first vendor has a marginal gain from this transition, there is a possibility of knowledge getting lost during the transition. Hence, it becomes important to capture the entire knowledge base from the primary vendor and transfer it to the new vendor. Also, the first vendor should be motivated enough to participate actively in this transition.

In light of the foregoing discussion, there is a need for a method and a system for efficiently transferring and monitoring the knowledge transfer in a reverse manner. The method and the system should enable knowledge transfer in a seamless manner, without requiring much effort and time from the customer.

### BRIEF SUMMARY OF THE INVENTION

Various embodiments of the invention provide a method and a system for seamlessly transferring knowledge of a project from a primary team to a secondary team. The invention provides a method and a system for monitoring and controlling knowledge transfer of the project. The invention is particularly applicable for reverse knowledge transfer mode, where the project was earlier commissioned by a customer to the primary team and needs to be transferred back to the secondary team.

The project includes various applications, such as software development applications and software maintenance applications. These applications include various phases of execution. For the purpose of knowledge transfer, the stages of knowledge transfer are determined. Further, a gating process is defined for each stage of all applications, which need to be transferred. The gating process defines the start and the completion dates baselines that need to be followed and assigns the responsibility for each stage to either of the stakeholders.

The knowledge transfer process is conducted by following the gating process for those phases of each application for which the gating process is defined. Further, the progress of knowledge transfer is reviewed after the completion of each stage for each application to ascertain that the gating processes are followed. The responsible team reviews the progress of each stage of each application and takes corrective actions.

The method and the system disclosed in the different embodiments of the invention provide various advantages. The transfer of knowledge takes place from the primary team to the secondary team in a structured manner. The knowledge transfer process is efficient, transparent, and seamless to the customer, and the committed deadlines are not compromised. Further, most of the responsibility for transferring knowledge lies with the primary team because of which the quality of knowledge transfer is maintained high.

### BRIEF DESCRIPTION OF THE DRAWINGS

Various embodiments of the invention will hereinafter be described in conjunction with the appended drawings provided to illustrate, and not to limit, the invention, wherein like designations denote like elements, and in which:

FIG. 1 illustrates an environment in which various embodiments of the invention may be practiced; and

FIG. 2 is a flowchart depicting a method for transferring knowledge from a primary team to a secondary team, in accordance with an embodiment of the invention.

### DETAILED DESCRIPTION

The invention relates to a process of transferring knowledge of a project from a primary team to a secondary team. The process involves assigning various responsibilities to different stakeholders involved in the transition and accordingly carrying out the knowledge transfer of all applications of the project.

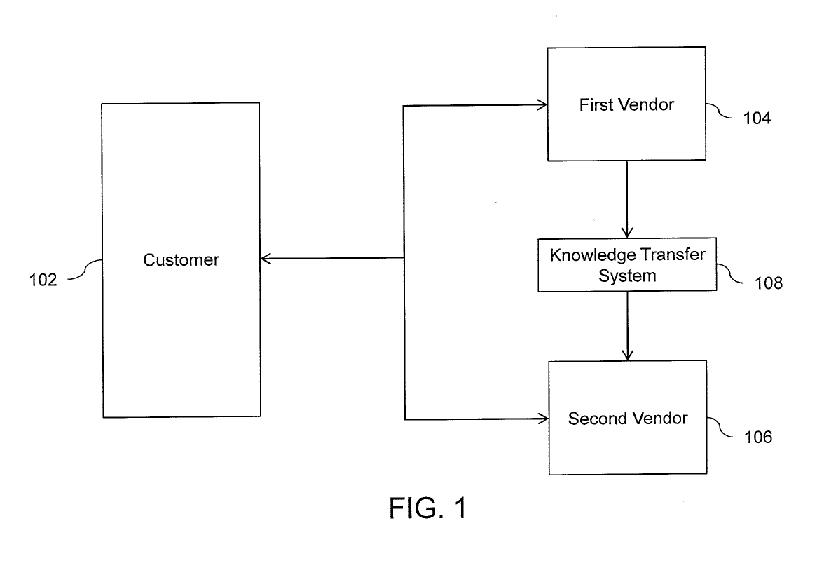

FIG. 1 illustrates an environment 100 in which various embodiments of the invention may be practiced. Environment 100 includes a customer 102, a first vendor 104, a second vendor 106, and a knowledge transfer system 108. Environment 100 provides a platform for interaction between different vendors, and outsourcing projects from customers 102 to first vendor 104 and second vendor 106. In an embodiment of the invention, environment 100 allows software development projects to be outsourced from customer 102 to second vendor 106 which was previously outsourced to first vendor 104.

In various embodiments of the invention, customer 102 is the end-client requiring services from one or more vendors, such as first vendor 104 and second vendor 106. The services may be categorized as Information Technology (IT) and Information Technology Enabled services (ITES). Examples of IT services include software development and maintenance support of an application platform. Examples of ITES services include customer care support and maintaining user record databases. The projects requiring these services may be commissioned by customer 102 to the corresponding team of first vendor 104 and second vendor 106. It may be understood to any person skilled in the art that these teams could be internal to the end-client organization, offshore teams, external onshore teams, and so forth.

In an embodiment of the invention, an application maintenance project is transitioned from first vendor 104 to second vendor 106. However, during this transition, it is required that the timelines for scheduled deliveries do not get affected. It is imperative for customer 102 that this transition takes place as smoothly as possible, without affecting the quality of work and timelines of completion of different phases of the applications. Knowledge of the entire project needs to be transferred from first vendor 104 to second vendor 106 for smooth transition, and the responsibility for knowledge transfer has to be shared between first vendor 104 and second vendor 106

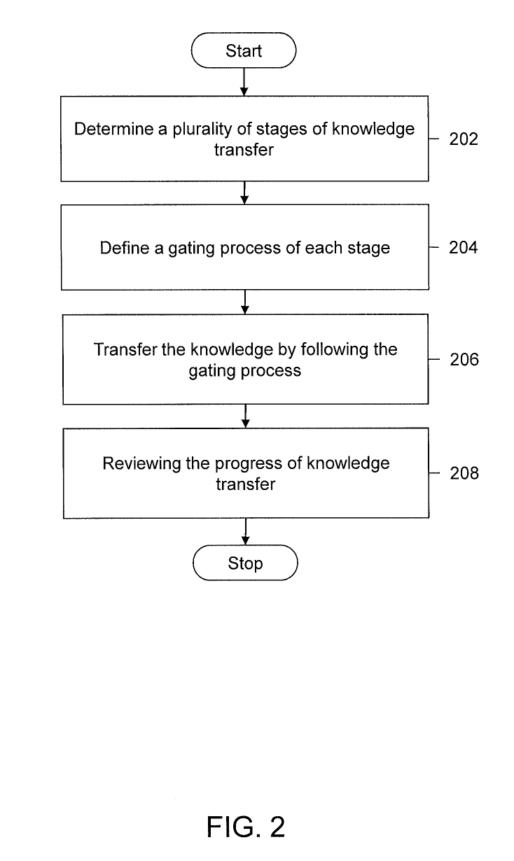

In various embodiments of the invention, knowledge transfer system 108 includes the details of the stages of knowledge transfer. These stages are defined to ensure smooth and structured transfer of knowledge between first vendor 104 and second vendor 106. These stages will be described in details in conjunction with FIG. 2.

Knowledge transfer system 108 also includes a gating module that provides a gating process of each stage of knowledge transfer. The gating process provides the start date and the completion date for each stage for all applications of the project. The gating module also includes the responsibility matrix for each stage. For each stage, either first vendor 104 or second vendor 106 is made responsible to carry out the knowledge transfer and ensure the quality standards and completion deadlines are met, in accordance with the responsibility matrix.

In an embodiment of the invention, the gating module is defined by first vendor 104. In another embodiment, the gating module is defined by customer 102.

FIG. 2 is a flowchart depicting a method for transferring knowledge from a primary team to a secondary team, in accordance with an embodiment of the invention. It will be understood to any person skilled in the art that the project may be transferred in parts to more than one secondary team.

At step 202, the stages of knowledge transfer are determined. The stages for knowledge transfer are initiation stage, transition training stage, system appreciation stage, shadowing stage, reverse shadowing stage, and steady state. In various embodiments of the invention, the stages are selected from the above mentioned set based on the nature of the application to be transitioned, type of phases involved, stage of application development when the transfer needs to be initiated, etc.

During the initiation stage, the process of knowledge transfer is initiated between the primary and the secondary teams. The complete transition planning for all applications is performed and various milestones are decided which need to be achieved by the primary and the secondary teams.

During the transition training stage, generally the primary team is responsible for imparting the training regarding the knowledge transfer processes to the secondary team. The secondary team is also informed about the responsibility matrix, different stages to be followed, timelines to be met, escalation process, etc.

During the system appreciation stage, the secondary team is apprised of the different processes in the applications, which phase each application is at, which milestones have been achieved, etc. The required documentation for the applications is shared with the secondary team. In an embodiment of the invention, relevant documents of all the phases of each application are shared with the secondary team. In another embodiment of the invention, only relevant documents of the remaining or ongoing phases of each application are shared with the secondary team. People responsible from the primary team corresponding applications transfer their knowledge of the applications to the assigned personnel of the secondary team. The required training is also conducted by the primary team during this stage.

During the shadowing stage, the secondary team shadows the primary team in the work being performed by it. The teams minutely observe each and every process, get acquainted with what has been accomplished and what remains, get all their doubts clarified, learn about new processes that have been followed, etc. At the end of this stage, the overall knowledge of the processes is deemed to be transferred to the secondary team

Similarly, during the reverse shadowing stage, the secondary team starts performing the processes and taking charge of the phases, while the primary team shadows them. The primary team observes how the processes are being carried out by the secondary team, and suggest changes in line with the preset guidelines. The primary team also verifies whether the secondary team is executing the processes in agreement with the committed deadlines and informs the customer and the secondary team in case of any discrepancy.

During the steady state stage, the involvement of the primary team is no longer required, as the processes have been completely transferred to the secondary team. At this stage, the secondary team has started executing all the steps and processes in a steady state, and the customer is rest assured that the timelines would be adequately met. At the steady state, the operational control is completely with the secondary team, and thereon the secondary team is solely responsible for the execution of the project.

At step 204, a gating process of each stage is defined for each application. The gating process includes a start date and a completion date of each stage, corresponding to each phase of every application. Transition guidelines, names of team members, required list of documents, presentation topics, training guidelines, case studies to be used, etc., are also included in the gating process. The transition guidelines may include identified risks, possible solutions, assumptions taken, etc. Further, a responsibility matrix is prepared, which needs to be followed by all the parties involved in the transition. The responsibility matrix is prepared considering that the previous committed deadlines for application releases and/or deployment are not compromised. This matrix assists in transferring the knowledge seamlessly between the teams. In various embodiments of the invention, the responsibility matrix is prepared by the primary team. The primary team, after finalizing the responsibility matrix, takes a sign off on the responsibility matrix from the secondary team and the customer. This helps the primary team in sharing responsibility with the other stakeholders of meeting the committed deadlines.

In an embodiment of the invention, a release deliverable matrix may also be prepared for a project, which involves an application development program. Along with the responsibility, this matrix states which team would be responsible for releasing different modules of the application. For example, if some modules of the applications have been released during the course of the knowledge transfer process, the application release still continues seamlessly, without the customer getting to realize the impact of knowledge transfer. Initial releases are taken care by the primary team, depending upon the start date of the phases involved. Along with the transition process, the responsibilities for application release are also transferred to the secondary team.

In another embodiment that involves onsite component, a roll-off plan is also prepared as a part of the gating process. The roll-off plan determines how many people would be required at onsite and at offshore locations for every application during different stages. In an embodiment of the invention, the names of these people and the exact dates of roll-off are also maintained in the roll-off plan. The roll-off plan supports in determining the capacity available from each team at different locations to take up knowledge transfer process along with the other processes of application development.

At step 206, the knowledge of different applications is transferred by following the gating process. Each stage of knowledge transfer is executed by the team responsible for it in accordance with the responsibility matrix. Further, the responsible team for each stage takes the consent of every other team involved in the knowledge transfer to ascertain that the gating processes are followed. It must be understood to any person skilled in the art that the knowledge transfer generally happens for different applications in parallel, although different applications may be running in different stages of knowledge transfer at any point of time.

At step 208, the progress of knowledge transfer is reviewed for compliance with the gating process. The other parameter on which the progress of knowledge transfer is reviewed is the quality of training and process knowledge that is imparted by the primary team to the secondary team. The progress of transition of each phase in every application is also tracked in accordance with the gating process. This review process also involves taking sign off from all parties involved in the knowledge transfer after the completion of each stage and before starting with the next stage. In various embodiments of the invention, the primary team is responsible for reviewing the progress of knowledge transfer. In an alternative embodiment of the invention, the customer may be responsible for reviewing the progress. In yet another embodiment of the invention, the responsibility of reviewing the progress knowledge transfer may be shared between the customer and the primary and the secondary teams.

In various embodiments of the invention, some corrective measures may be taken based on the review after the completion of each stage. One such example of the corrective action is modifying responsibilities for one or more stages. This action may be taken based on the performance of the responsible team in carrying out the knowledge transfer in the transfer process. Another example of corrective action comprises redefining the gating process for one or more stages for at least one of the application. Redefining the gating process may include changing the start date and the completion date of one or more stages of knowledge transfer.

Once the steady state of reached for any application, the operation control is with the secondary team for that application. The secondary team is solely responsible for the execution of the project, after the completion of the knowledge transfer, i.e., the steady state is reached for all applications.

The method and the system disclosed in the different embodiments of the invention provide various advantages. The transfer of knowledge takes place from the primary team to the secondary team in a structured manner. The transfer process is completely transparent and seamless to the customer, and the committed deadlines are not compromised. Further, most of the responsibility for transferring knowledge lies with the primary team, because of which the quality of knowledge transfer is maintained.

The method and the system for transferring knowledge of a project from a primary team to a secondary team, as described in the present invention, may be embodied in the form of a computer program product, for use in a computer system. The computer program product includes a computer-usable medium having a computer readable program code. Typical examples of a computer system include a general-purpose computer, a programmed microprocessor, a micro-controller, a peripheral integrated circuit element, and other devices or arrangements of devices that are capable of implementing the steps that constitute the method for the present invention.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be other similar means for loading computer programs or other instructions into the computer system.

The computer system executes a set of instructions that are stored in one or more storage elements to process input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as CD-ROMS, Flash chips, and floppy disks.

The set of instructions may include various commands that instruct the processing machine to perform specific tasks, such as the steps that constitute the method for the present invention. The set of instructions may be in the form of a software program. The software may be in various forms, such as system software or application software. Further, the software may be in the form of a collection of separate programs, a program module with a large program, or a portion of a program module. The software may also include modular programming in the form of object-oriented programming. The software program that contains the set of instructions (program instruction means) can be embedded in a computer program product for use with a computer, the computer program product comprising a computer-usable medium with a computer-readable program code embodied therein. The processing of input data by the processing machine may be in response to users' commands, results of previous processing, or a request made by another processing machine.

The modules described herein may include processors and program instructions that are used to implement the described functions of the modules. Some or all the functions can be implemented by a state machine that has no stored program instructions, or in one or more Application-Specific Integrated Circuits (ASICs), in which each function or some combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

1. A method for monitoring and controlling knowledge transfer of a project, the project comprising a plurality of applications, each of the plurality of applications comprising one or more phases of execution, the knowledge being transferred from a primary team to one or more secondary teams, the primary team being different from an end-client commissioning the project, the method comprising:
determining a plurality of stages of knowledge transfer, the plurality of stages being applicable to one or more of the plurality of applications;
defining a gating process of each stage for each of the plurality of applications, wherein defining the gating process includes assigning responsibility of each stage to at least one of the primary team and the one or more secondary teams;
transferring the knowledge by following the gating process during at least one phase of each of the plurality of applications from the primary team to at least one of the one or more secondary teams, wherein the plurality of stages are defined for the at least one phase of each of the plurality of applications; and
reviewing the progress of knowledge transfer after completion of each stage for each application to ascertain that the gating processes are followed, the progress being reviewed by the responsible team for each stage.

2. The method of claim 1, wherein the plurality of stages are determined from the group comprising initiation stage, transition training, system appreciation stage, shadowing stage, reverse shadowing stage, and steady state.

3. The method of claim 1, wherein each stage of knowledge transfer is executed by the responsible team.

4. The method of claim 1, wherein the responsible team for each gating process takes the consent of every team involved in the knowledge transfer to ascertain that the gating processes are followed.

5. The method of claim 1, wherein defining gating processes comprises determining a start date and a completion date for each stage for the plurality of applications.

6. The method of claim 1 further comprising taking corrective measures based on the review after completion of each stage.

7. The method of claim 6, wherein the corrective action comprises modifying responsibilities for one or more stages.

8. The method of claim 6, wherein the corrective action comprises redefining the gating process for one or more stages for at least one of the application.

9. The method of claim 1, wherein the one or more secondary teams are responsible for the execution of the project after completion of the knowledge transfer.

10. A knowledge transfer system for transferring knowledge of a project from a primary team to one or more secondary teams, the primary team being different from an end-client commissioning the project, the project comprising a plurality of applications, the knowledge transfer system comprising:
a plurality of stages of knowledge transfer, the plurality of stages being applicable to one or more of the plurality of applications; and
a gating module, the gating module including a gating process of each stage for each of the plurality of applications, the gating module further including assigned responsibility of each stage to at least one of the primary team and the one or more secondary teams.

11. The knowledge transfer system of claim 10, wherein the plurality of stages are selected from the group comprising initiation stage, transition training, system appreciation stage, shadowing stage, reverse shadowing stage, and steady state.

12. The knowledge transfer system of claim 10, wherein the gating process comprises a start date and a completion date for each stage for the plurality of applications.

13. A computer program product for use with a computer, the computer program product comprising a computer usable medium having a computer readable program code embodied therein for monitoring and controlling knowledge transfer of a project, the project comprising a plurality of applications, each of the plurality of applications comprising one or more phases of execution, the knowledge being transferred from a primary team to one or more secondary teams, the primary team being different from an end-client commissioning the project, the computer readable program code comprising:
instructions for determining a plurality of stages of knowledge transfer, the plurality of stages being applicable to one or more of the plurality of applications;
instructions for defining a gating process of each stage for each of the plurality of applications, wherein defining the gating process includes assigning responsibility of each stage to at least one of the primary team and the one or more secondary teams;
instructions for transferring the knowledge by following the gating process during at least one phase of each of the plurality of applications from the primary team to at least one of the one or more secondary teams, wherein the plurality of stages are defined for the at least one phase of each of the plurality of applications; and
instructions for reviewing the progress of knowledge transfer after completion of each stage for each application to ascertain that the gating processes are followed, the progress being reviewed by the responsible team for each stage.

14. The computer program product according to claim 13, wherein the plurality of stages are determined from the group comprising initiation stage, transition training, system appreciation stage, shadowing stage, reverse shadowing stage, and steady state.

15. The computer program product according to claim 13, wherein defining gating processes comprises determining a start date and a completion date for each stage for the plurality of applications.

16. The computer program product according to claim 13, the computer readable program code further comprising instructions for performing taking corrective measures based on the review after completion of each stage.

17. The computer program product according to claim 16, wherein the corrective action comprises modifying responsibilities for one or more stages.

18. The computer program product according to claim 16, wherein the corrective action comprises redefining the gating process for one or more stages for at least one of the application.
